(19) United States
(12) Patent Application Publication
(10) Pub. No.: US 2008/0170022 A1
(43) Pub. Date: Jul. 17, 2008

(54) Pixel driving circuit

(75) Inventors: Heng-Yin Chen, Hsin Chu Hsien (TW); Jih-Fon Huang, Hsin Chu Hsien (TW); Chih-Tsung Tsai, Hsin Chu Hsien (TW); Hung-Wei Li, Hsin Chu Hsien (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/808,199

(22) Filed: Jun. 7, 2007

(30) Foreign Application Priority Data
Jan. 11, 2007 (TW) 96101052

(51) Int. Cl. G09G 3/36

(52) U.S. Cl. 345/92

(57) ABSTRACT

A pixel driving circuit of this invention utilizes a storage capacitor and an active loading circuit to serve as a pixel data storage buffer for each pixel. The pixel driving circuit of this invention can write the whole-panel pixel data for a next frame in these storage buffers during the illuminating time of a backlight. When changing the frames, the whole-panel pixels synchronously read the pixel data pre-stored in these storage buffers. As a result, the write-in time of the whole-panel pixel data is reduced and the illuminating time of the backlight is relatively increased.

### BACKGROUND OF THE INVENTION

1. Field of the Invention

The present invention relates to a pixel driving circuit of an active matrix liquid crystal display, and more particularly to a pixel driving circuit with a pixel data storage buffer.

2. Description of the Related Art

In the conventional display technique employing the color sequential method, the backlight is turned on only after the whole-panel liquid crystals are transferred to stable states so as to avoid a chaotic display happening. It is an important issue to how to prompt the driving of the liquid crystals. Please refer to FIG. 1A and FIG. 1B, U.S. Pat. No. 6,181,311 assigned to Canon disclosed a pixel driving circuit to resolve the problem of the compression of the illuminating time of the backlight in the conventional color sequential method implemented in the conventional 1T1C pixel architecture. The difference between Canon's pixel circuit and the conventional 1T1C pixel circuit is Canon's pixel circuit additionally has a signal storage capacitor Cₛ₁, a signal transfer transistor 102 and a reset transistor 103 except for employing a transistor 101 to write in the pixel data voltage. The signal storage capacitor Cₛ₁ is used for pre-storing a pixel data of a next frame, and the signal transfer transistor 102 is used for transferring the pixel data voltage pre-stored in the signal storage capacitor Cₛ₁ to a corresponding pixel data storage capacitor Cₛ₂. The reset transistor 103 is used to delete the residue charges of the pixel capacitor to avoid color deviation caused by the residue charges. But Canon's pixel circuit design encounters the problem of charge-sharing. As a consequence, Canon's pixel circuit design needs a large signal storage capacitor Cₛ₁, which makes an aperture ratio of the liquid crystal panel become very small. For the above concern, Canon provides another pixel circuit design in the same patent, as shown in FIG. 2A and FIG. 2B, in this pixel circuit design, except for employing a transistor 201 to write in the pixel data and a signal transfer transistor 204, Canon utilizes two N-channel transistors 202, 203 to constitute an active circuit to directly transfer the pixel data voltage pre-stored in the signal storage capacitor C₁ to a corresponding pixel data storage capacitor C₂. But this pixel circuit design still has a problem that the transistors are large so as to shrink the aperture ratio of the liquid crystal panel.

Additionally, please refer to FIG. 3, U.S. Pat. No. 7,006,066 provides a pixel driving circuit for a liquid crystal cell 403, in which the liquid crystal cell 403 is sandwiched between a pair of electrodes 401 and 402. This pixel circuit design still has an over-sized capacitor, and resulting in the aperture ratio of the liquid crystal panel is too small. Moreover, this pixel circuit design requires two sets of signal lines, two sets of scan lines, two sets of signal write-in circuits and two sets of scan line driving circuits. The pixel circuit design becomes more complicated.

### SUMMARY OF THE INVENTION

The present invention provides a pixel driving circuit employing pixel data storage buffers to pre-store pixel data of a next frame of the whole panel during an illuminating time of a backlight, and when changing a frame, the whole-panel pixels synchronously read the pixel data pre-stored in the corresponding pixel data storage buffers, and hence write-in time of the pixel data can be reduced, the illuminating time of the backlight is relatively increased.

In another aspect, the pixel driving circuit of the present invention utilizes the storage capacitor to pr-store one of the pixel data of the next frame, and electrically coupling a high-voltage-level electrode of the storage capacitor to a signal transfer line, which controls the pre-stored pixel data to transfer to a corresponding pixel capacitor, and utilizing the signal transfer line to output different transfer signal voltages such that when the pixel data is transferred, the pixel capacitor can have different voltage levels so as to extend the range of the pixel data voltage of the pixel capacitor.

According to the above, the present pixel driving circuit includes a first transistor, a first storage capacitor, an active loading circuit, a fourth transistor and a second storage capacitor. The first transistor has a gate, a source and a drain, in which the gate is electrically coupled to a pixel scan line and the source is connected to a pixel data line. The first storage capacitor has a first end and a second end. The first end of the first storage capacitor is coupled to the drain of the first transistor and the second end thereof is grounded. A pixel data of a next frame is pre-stored in the first storage capacitor by switching on the first transistor through the pixel scan line. The active loading circuit includes a second transistor and a third transistor, in which each of the second transistor and third transistor has a gate, a source and a drain, the source of the second transistor is connected to the drain of the third transistor, the gate and drain of the second transistor are electrically coupled to a voltage signal line, and the gate of the third transistor is electrically coupled to the first end of the first storage capacitor and the source thereof is grounded. The fourth transistor has a gate, a source and a drain, in which the gate is electrically coupled to a signal transfer line and the source is connected to the source of the second transistor and the drain of the third transistor. The second storage capacitor has a first end and a second end. The first end of the second storage capacitor is electrically coupled to the drain of the fourth transistor and a high-voltage-level electrode of a pixel and the second end thereof is grounded. The pixel data pre-stored in the first storage capacitor is transferred to the second storage capacitor by switching on the fourth transistor through the signal transfer line.

The present invention utilizes a first storage capacitor and an active loading circuit to constitute a pixel data storage buffer to pre-store a pixel data of a next frame during the illuminating time of the backlight so that the write-in time of the whole-panel pixel data can be reduced, and the illuminating time of the backlight can be increased.

The present invention provides another pixel driving circuit, which includes a first transistor, a first storage capacitor, a second transistor, a second storage capacitor and a third transistor. The first transistor has a gate, a source and a drain, in which the gate is electrically coupled to a pixel scan line and the source is electrically coupled to a pixel data line. The first storage capacitor has a first end and a second end. The first end of the first storage capacitor is electrically coupled to a signal transfer line and the second end thereof is electrically coupled to the drain of the first transistor. A pixel data of a next frame is pre-stored in the first storage capacitor by switching on the first transistor through the pixel scan line. The second transistor has a gate, a source and a drain, in which the gate is electrically coupled to the signal transfer line and the source thereof is electrically coupled to the second end of the first storage capacitor. The second storage capacitor has a first end and a second end. The first end of the second storage capacitor is electrically coupled to the drain of the second transistor and a high-voltage-level electrode of a pixel and the second end thereof is grounded. The pixel data pre-stored in the first storage capacitor is transferred to the second storage capacitor by switching on the second transistor through the signal transfer line, and adjusting a voltage level of the high-voltage-level electrode of the pixel by the signal transfer line electrically coupled to the first end of the first storage capacitor. The third transistor has a gate, a source and a drain, in which the gate is electrically coupled to a signal reset line, the source is electrically coupled to the high-voltage-level electrode of the pixel and the drain is grounded. The reset signal line is used to switch on the third transistor to delete the residue pixel data before the pixel data is transferred to the second storage capacitor.

In the above-mentioned another pixel driving circuit, the present invention utilizes two storage capacitors and three transistors to serve as a driving circuit of a corresponding pixel. The first storage capacitor is used as a storage buffer for storing the write-in pixel data and the second storage capacitor is used for storing the pixel data. The present invention utilizes this design of pixel driving circuit to pre-store the pixel data of the next frame during the illuminating time of the backlight, and when changing a frame, transferring the pre-stored pixel data of the whole panel to all of the second storage capacitors. As such, the write-in time of the pixel data of the whole panel can be reduced, and the illuminating time of the backlight is relatively increased.

### BRIEF DESCRIPTION OF THE DRAWINGS

FIG. 1A is a schematic view of a well-known pixel driving circuit;

FIG. 1B is a timing diagram of the control signals of the pixel driving circuit of FIG. 1A;

FIG. 2A is a schematic view of another well-known pixel driving circuit;

FIG. 2B is a timing diagram of the control signals of the pixel driving circuit of FIG. 2A;

FIG. 3 is a schematic view of another well-known pixel driving circuit;

FIG. 4A is a schematic view of a pixel driving circuit according to a first embodiment of the present invention;

FIG. 4B is a timing diagram of the control signals of the pixel driving circuit of FIG. 4A;

FIG. 5A is a schematic view of a pixel driving circuit according to a second embodiment of the present invention;

FIG. 5B is a timing diagram of the control signals of the pixel driving circuit of FIG. 5A;

FIG. 6A is a schematic view of a pixel driving circuit according to a third embodiment of the present invention;

FIG. 6B is a timing diagram of the control signals of the pixel driving circuit of FIG. 6A;

FIG. 7A is a schematic view of a pixel driving circuit according to a fourth embodiment of the present invention;

FIG. 7B is a timing diagram of the control signals of the pixel driving circuit of FIG. 7A;

FIG. 8A is a schematic view of a pixel driving circuit according to a fifth embodiment of the present invention;

FIG. 8B is a timing diagram of the control signals of the pixel driving circuit of FIG. 8A;

FIG. 9A is a schematic view of a pixel driving circuit according to a sixth embodiment of the present invention; and

FIG. 9B is a timing diagram of the control signals of the pixel driving circuit of FIG. 9A.

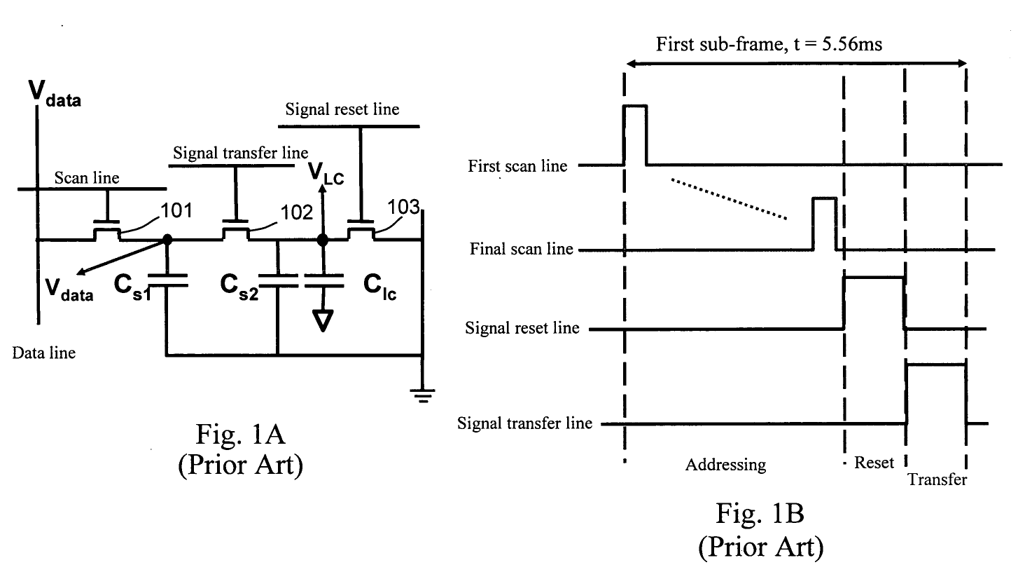

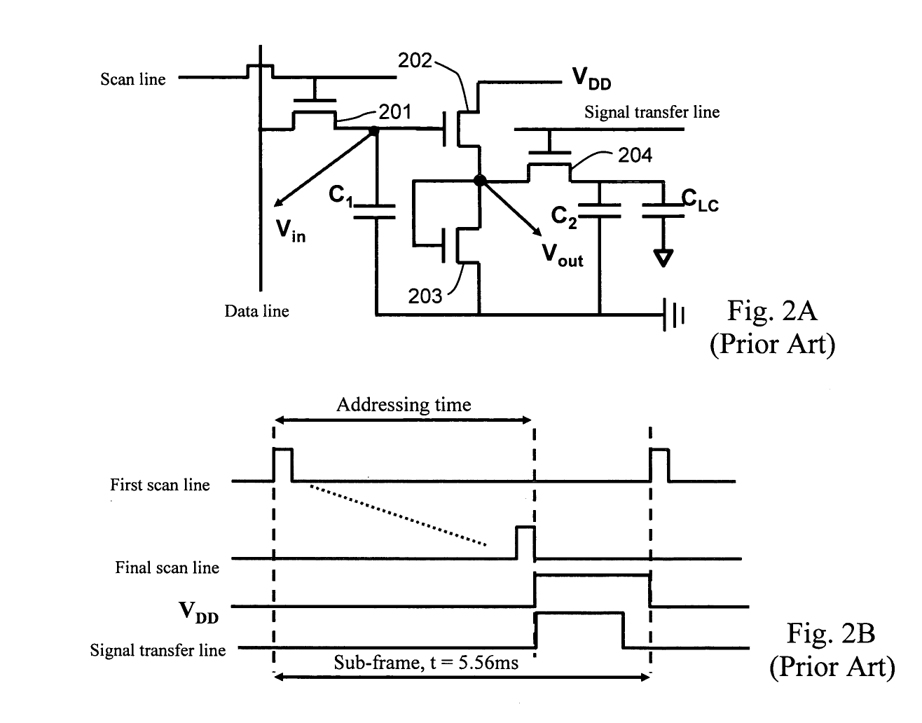

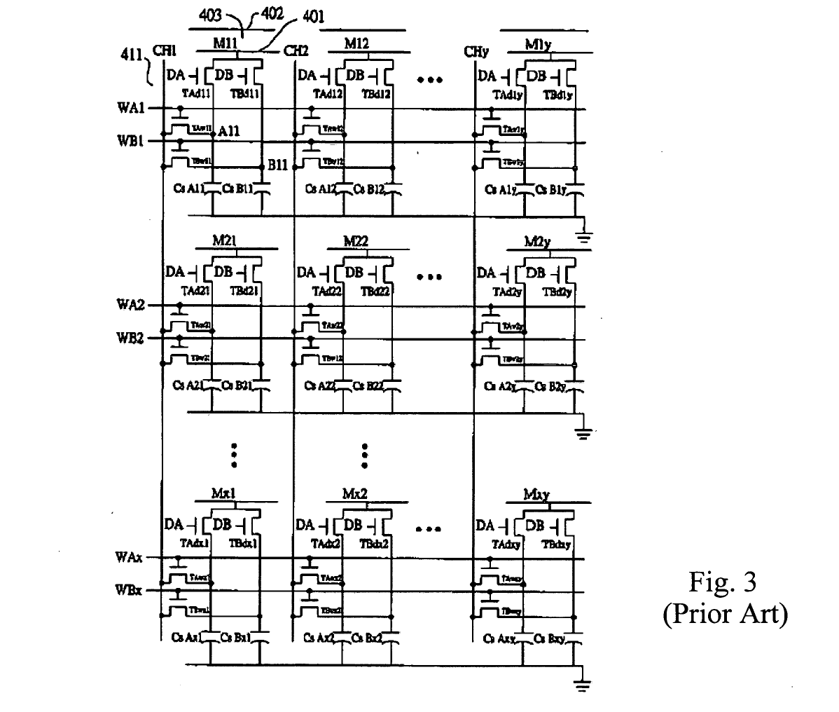

### DETAILED DESCRIPTION OF THE PREFERRED EMBODIMENTS

The pixel driving method of the liquid crystal display device is divided into three sections, i.e. a period of writing in pixel data, a response period of the liquid crystal and an illuminating period of the backlight. The present invention provides a pixel driving circuit with a frame storage buffer for a liquid crystal display device, which pre-stores pixel data voltages of a next frame during the illuminating period of the backlight such that the backlight could have longer illuminating time for each frame and the illuminating brightness is thus enhanced.

In another aspect, the present invention utilizes a storage capacitor (also called memory capacitor) and an active loading circuit to be served as a pixel voltage storage buffer for a corresponding pixel. As such, during the illuminating time of the backlight, the whole-panel pixel data voltages of the next frame can be previously written in the corresponding storage buffers, and when changing a frame, all the whole-panel pixels synchronously read the data pre-stored in the corresponding storage buffers. As a result, the writing-in time of the whole-panel pixel data can be reduced and the illuminating time of the backlight is relatively increased.

In a further aspect, the pixel driving circuit of the present invention utilizes two storage capacitors and three transistors to be served as a driving circuit of a corresponding pixel, in which a first storage capacitor is used as a storage buffer for pre-storing writing-in pixel data, a second storage capacitor is used for storing the pixel data voltage. By this kind of pixel driving circuit design, all the whole-panel pixel data of the next frame could be previously written in the corresponding first storage capacitors during the illuminating period of the backlight, and when changing a frame, all the pixel data voltages pre-stored in the first storage capacitors are synchronously transferred to the corresponding second storage capacitors. As such, the writing-in time of the whole-panel pixel data can be reduced and the illuminating time of the backlight is relatively increased.

The pixel driving circuit of the present invention will be described in detail in accordance with following preferred embodiments and accompanying drawings.

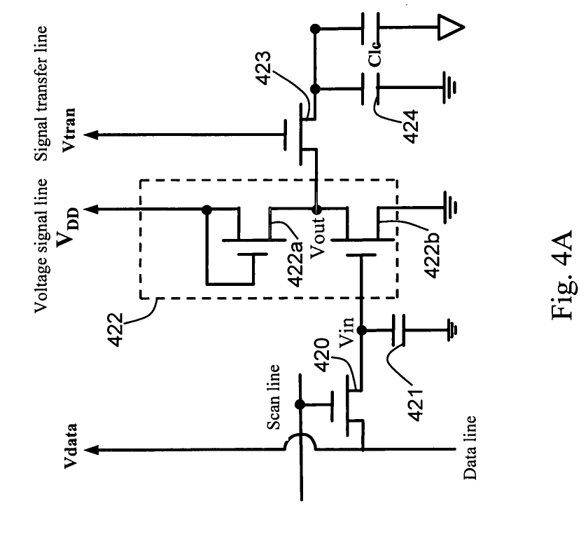

FIG. 4A is a schematic view of a pixel driving circuit for a corresponding pixel according to a first embodiment of the present invention. FIG. 4B is a timing diagram of various control signals of the pixel driving circuit of FIG. 4A for a frame. In the first embodiment, the pixel driving circuit for a corresponding pixel includes a first transistor 420, a first storage capacitor 421, an active loading circuit 422 including a second transistor 422a and a third transistor 422b, a fourth transistor 423 and a second storage capacitor 424. The first transistor 420 is an N-channel transistor having a gate, a source and a drain, in which the gate is electrically coupled to a pixel scan line, and the source is connected to a pixel data line. The first storage capacitor 421 has a first end and a second end. The first end of the first storage capacitor 421 is coupled to the drain of the first transistor 420 and the second end thereof is grounded. The first transistor 420 is used as a pixel data writing-in switch. The first transistor 420 is switched on through the pixel scan line so as to previously write a pixel data of a next frame in the first storage capacitor 421. The active loading circuit 422, for example an active inverter, whose second transistor 422a and third transistor 422b are N-channel transistors, each of which having a gate, a source and a drain. The source of the second transistor 422a is connected to the drain of the third transistor 422b. The gate and drain of the second transistor 422a is electrically coupled to a voltage signal line. The gate of the third transistor 422b is electrically coupled to the first end of the first storage capacitor 421, and the source thereof is grounded. The fourth transistor 423 is an N-channel transistor having a gate, a source and a drain, in which the gate is electrically coupled to a signal transfer line, and the source is connected to the source of the second transistor 422a and the drain of the third transistor 422b. The second storage capacitor 424 has a first end and a second end. The first end of the second storage capacitor 424 is electrically coupled to the drain of the fourth transistor 423 and a high-voltage-level electrode of a corresponding pixel (i.e. pixel capacitor Clc), and the second end thereof is grounded or connected to a voltage source (not shown). The fourth transistor 423 is used as a signal transfer switch. The fourth transistor 423 is switched on through the signal transfer line so as to transfer the pixel data pre-stored in the first storage capacitor 421 to the second storage capacitor 424 to apply the pixel data voltage to the high-voltage-level electrode of the corresponding pixel.

In the first embodiment, the present invention utilizes the first storage capacitor 421 and the active loading circuit 422 to constitute a pixel data storage buffer so that the whole-panel pixel data of the next frame can be previously written in the corresponding pixel data buffer storages during the illuminating time of the backlight. The pixel driving method of the first embodiment will be described in detail accompanying with the drawings of FIG. 4A and FIG. 4B.

Firstly, a first pixel scan line delivers a scan driving voltage to the first transistor 420 to switch on the first transistor 420, and then a pixel data voltage is stored in the first storage capacitor 421 through a pixel data line. Next, all the pixel scan lines of the whole panel are sequentially scanned to pre-store the pixel data voltages of the whole panel in the corresponding storage capacitors 421. Thereafter, the signal transfer lines respectively corresponding to the whole-panel pixels synchronously transmit a signal transfer voltage Vtran to all the corresponding fourth transistors 423 to switch on the fourth transistors 423, and all the voltage signal lines also synchronously deliver a voltage signal V_{DD} to the corresponding active loading circuits 422. In this kind of pixel driving circuit design, a formula for transferring an output voltage is Vout=V_{DD}−Vin, in which Vin is a voltage of a first end of the first storage capacitor 421, and Vout is an output voltage of the active loading circuit 422, which is electrically coupled to the source of the fourth transistor 423. When all the fourth transistors 423 are switched on, the voltages Vout are directly relied on the voltages Vin of the first ends of the first storage capacitors 21, and the voltages Vout are written in the second storage capacitors 424 such that all the pixel data voltages pre-stored in the first storage capacitors 420 are transferred to the corresponding second storage capacitors 424. And hence, all the pixel data voltages are respectively applied to the high-voltage-level electrodes of the corresponding liquid crystal capacitors (Clc). After that, all the fourth transistors 423 are switched off. Once all the liquid crystals are transferred to the stable states, the backlight is tuned on, and at the same time the whole-panel pixel data of the next frame are sequentially written in the corresponding first storage capacitors 421.

In the first embodiment, the formula for transferring the pixel data voltage of the pixel data voltage storage buffer is Vout=V_{DD}−Vin. Therefore, the pixel dada voltage Vin written in the pixel data voltage storage buffer can directly determine the output voltage Vout of the pixel data, and hence directly determines the pixel data voltage of the first end of the second storage capacitor 424. As such, the first storage capacitors 421 of the pixel driving circuit of the first embodiment do not need to be large. The aperture ratio of the liquid crystal panel can be increased.

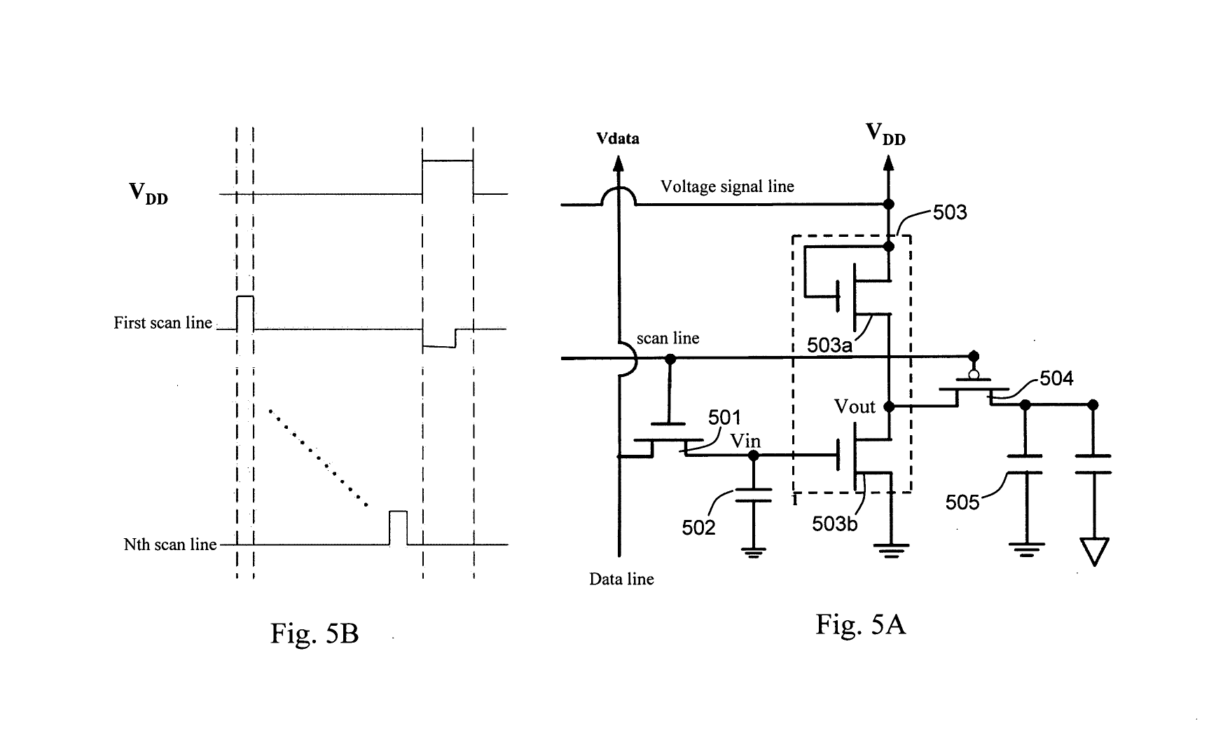

FIG. 5A is a schematic view of a pixel driving circuit for a corresponding pixel according to a second embodiment of the present invention. FIG. 5B is a timing diagram of various control signals of the pixel driving circuit of FIG. 5A for a frame. In the second embodiment, the pixel driving circuit for a corresponding pixel of the present invention includes a first transistor 501, a first storage capacitor 502, an active loading circuit 503 including a second transistor 503a and a third transistor 503b, a fourth transistor 504 and a second storage capacitor 505. The first transistor 501 is an N-channel transistor having a gate, a source and a drain, in which the gate is electrically coupled to a pixel scan line, and the source is connected to a pixel data line. The first storage capacitor 502 has a first end and a second end. The first end of the first storage capacitor 502 is coupled to the drain of the first transistor 501, and the second end thereof is grounded. The first transistor 501 is served as a pixel data writing-in switch. The pixel scan line switches on the first transistor 501 to pre-store the pixel data of the next frame to the first storage capacitor 502. The active loading circuit 503, for example an active inverter, whose second transistor 503a and third transistor 503b are N-channel transistors, each of which having a gate, a source and a drain. The source of the second transistor 503a is connected to the drain of the third transistor 503b. The gate and drain of the second transistor 503a are electrically coupled to a voltage signal line (V_{DD}). The gate of the third transistor 503b is electrically coupled to the first end of the first storage capacitor 502, and the source thereof is grounded. The fourth transistor 504 is a P-channel transistor having a gate, a source and a drain, in which the gate is electrically coupled to the pixel scan line, and the source is connected to the source of the second transistor 503a and the drain of the third transistor 503b. The second storage capacitor 505 has a first end and a second end. The first end of the second storage capacitor 505 is electrically coupled to the drain of the fourth transistor 504 and a high-voltage-level electrode of a corresponding pixel (pixel capacitor Clc), and the second end thereof is grounded or connected to a voltage source (not shown). The fourth transistor 504 is served as a signal transfer switch. The pixel scan line is also served as a signal transfer line to switch on the fourth transistor 504 to transfer the pixel data pre-stored in the first storage capacitor 502 to the second storage capacitor 505 so as to apply the pixel data voltage to the high-voltage-level electrode of the corresponding pixel.

The difference between the second embodiment and the first embodiment is the fourth transistor 504 becomes a P-channel transistor, and whose gate is electrically coupled to the pixel scan line, and with appropriate signal sequence control to employ the pixel scan line as the signal transfer line. Please refer to FIG. 5B, after scanning the whole-panel pixel scan lines, the whole-panel pixel scan lines deliver a negative voltage signal to the respective fourth transistors 504 to switch on them such that the pixel data pre-stored in the first storage capacitors 502 are transferred to the first ends of the second storage capacitors 505. As a result, the pixel data voltages are applied to the high-voltage-level electrodes of the respective liquid crystal capacitors (Clc). After the pixel data voltages are written in the second storage capacitors 505, all the fourth transistors 504 are switched off. Once all the liquid crystals are transferred to the stable states, the backlight is tuned on. At the same time, the whole-panel pixel data of the next frame are sequentially written in the respective first storage capacitors 501.

In the second embodiment, the present invention utilizes the first storage capacitor 502 and the active loading circuit 503 to constitute a pixel data voltage storage buffer so as to previously write in the pixel data of the next frame to the pixel data voltage storage buffer during the illuminating time of the backlight. Likewise, the formula for transferring the pixel data voltage of the pixel data voltage storage buffer is Vout=V_{DD}−Vin. The pixel data voltage Vin written in the pixel data voltage storage buffer can directly determine the output voltage Vout of the pixel data and hence directly determines the pixel data voltage of the first end of the second storage capacitor 505. As a result, the first storage capacitors 502 of the second embodiment do not need to be large, and the aperture ratio of the liquid crystal panel is increased.

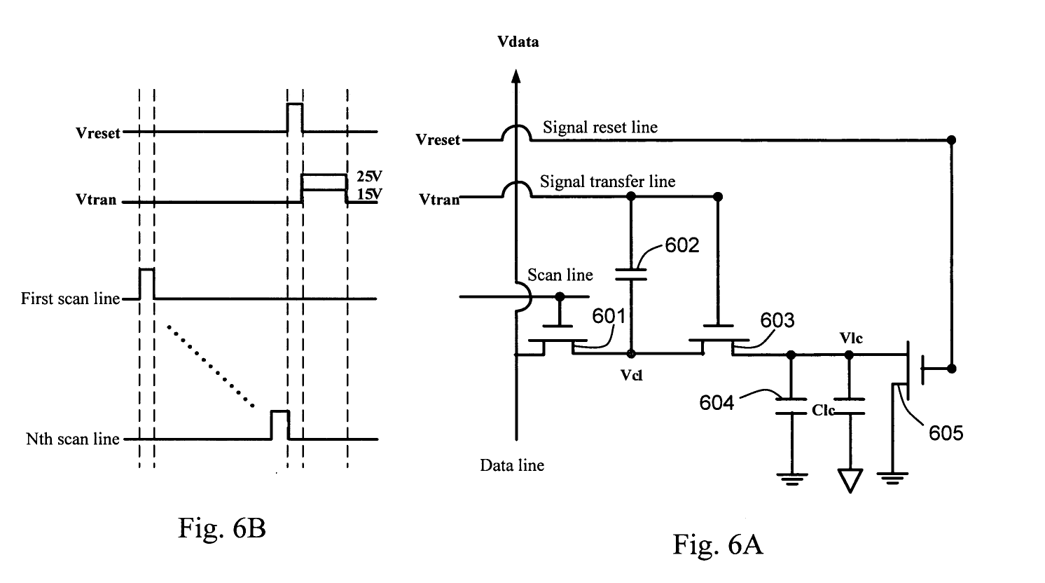

FIG. 6A is a schematic view of a pixel driving circuit for a corresponding pixel according to a third embodiment of the present invention. FIG. 6B is a timing diagram of various control signals of the pixel driving circuit of FIG. 6A for a frame. In the third embodiment, the pixel driving circuit for a corresponding pixel of the present invention includes a first transistor 601, a first storage capacitor 602, a second transistor 603, a second storage capacitor 604 and a third transistor 605. The first transistor 601 is an N-channel transistor having a gate, a source and a drain, in which the gate is electrically coupled to a pixel scan line, and the source is electrically coupled to a pixel data line. The first storage capacitor 602 has a first end and a second end. The first end of the first storage capacitor 602 is electrically coupled to a signal transfer line, and the second end thereof is electrically coupled to the drain of the first transistor 601. The first transistor 601 is served as a pixel data writing-in switch. The pixel scan line switches on the first transistor 601 to pre-store the pixel data of the next frame to the first storage capacitor 602. The second transistor 603 is an N-channel transistor having a gate, a source and a drain, in which the gate is electrically coupled to the signal transfer line, and the source is electrically coupled to the second end of the first storage capacitor 602. The second storage capacitor 604 has a first end and a second end. The first end of the second storage capacitor 604 is electrically coupled to the drain of the second transistor 603 and a high-voltage-level electrode of a corresponding pixel (Clc), and the second end is grounded or connected to a voltage source such as the Vreset (not shown). The second transistor 603 is a signal transfer switch to switch on the second transistor 603 so as to transfer the pixel data pre-stored in the first storage capacitor 602 to the second storage capacitor 604, and by the signal transfer line also electrically coupled to the first end of the first storage capacitor 602 to adjust the voltage level of the high-voltage-level electrode of the corresponding pixel. And by the signal transfer line outputting the different signal transfer voltages Vtran, the voltage level of the high-voltage-level electrode of the corresponding pixel can be adjusted before the pixel data voltage is transferred. As such, the range of the pixel data voltage applied to the high-voltage-level electrode of the pixel is extended. The third transistor 605 is an N-channel transistor having a gate, a source and a drain, in which the gate is electrically coupled to a signal reset line, the source is electrically coupled to the high-voltage-level electrode of the pixel, and the drain is connected to a voltage source, such as a ground voltage or the data line (not shown). The third transistor 605 is served as a reset transistor. The signal reset line switches on the third transistor 605 such that the residue pixel data of the pixel capacitor (Clc) is deleted before the pixel data is transferred to the second storage capacitor 604.

In this kind of pixel driving circuit design, the charges C1 stored in the first storage capacitor 602 is approximately equal to a sum of the charges Cst stored in the second storage capacitor 604 and the charges of the pixel capacitor Clc i.e. C1˜Cst+Ccl. As such, when the charges are transferred, the charges are evenly distributed at two ends of the second transistor 603. When the range of the pixel data voltage written in the first storage capacitor 602 is 0˜10 volts, the pixel capacitor Clc gets a pixel data voltage range about 0˜5 volts after the pixel data voltage is transferred. Nevertheless, the voltage Vlc of the pixel electrode is desired to have the range of 0˜10 volts as same as the first storage capacitor 602. To increase the voltage range of the high-voltage-level electrode of the pixel capacitor Clc after the pixel data voltage is transferred such that the voltage range of the high-voltage-level electrode of the pixel capacitor Clc is consistent with the writing-in pixel data voltage range, i.e. 0˜10 volts, in this kind of pixel driving circuit design, the first end of the first storage capacitor 602 is electrically coupled to the signal transfer line. By the signal transfer line outputting the different signal transfer voltages Vtran, the first end of the first storage capacitor 602 has different voltage levels Vdata+Vtran, and hence the high-voltage-level electrode of the pixel capacitor Clc has different voltage levels Vlc, and the purpose for having the pixel data voltage range about 0˜10 volts is attained. Besides, the first storage capacitor 602 does not need to be larger than the second storage capacitor 604 and the pixel capacitor Clc. The size of the first storage capacitor 602 is effectively decreased, and the aperture ratio of the liquid crystal panel is increased.

In the third embodiment, the present invention utilizes two storage capacitors and three transistors to constitute a pixel driving circuit, and with appropriate signal sequence control to complete the pre-storage of the pixel data voltages. The pixel driving method of the pixel driving circuit of the third embodiment will be described in detail accompanying with the drawings of FIG. 6A and FIG. 6B.

Firstly, the first pixel scan line delivers a scan driving voltage to the first transistor 601 to switch on the first transistor 601, and then the pixel data voltage is delivered to the first storage capacitor 602 through the pixel data line. Next, the pixel scan lines of the whole panel are sequentially scanned so as to store the whole-panel pixel data voltages to the respective first storage capacitors 602. Thereafter, the respective signal reset lines of the whole-panel pixels deliver a reset signal (Vreset) to the corresponding third transistors 605 so as to synchronously switch on the third transistors (reset transistors) 605 to delete the residue pixel data of the whole-panel pixel capacitors Clc. After the whole-panel pixel capacitors are reset, all the third transistors 605 are switched off, by all the signal transfer lines synchronously transmitting a signal transfer voltage Vtran to the corresponding second transistors 603 to switch on the second transistors 603, and hence the pixel data pre-stored in the first storage buffers 602 are synchronously transferred to the corresponding second storage, capacitors 604 such that all the pixel data voltages are applied to the high-voltage-level electrodes of the respective pixel capacitors Clc. At this time, the voltage levels of the first ends of the first storage capacitors 602 are boosted to Vdata+Vtran, and at the same time partial charges are transferred to the corresponding second storage capacitors 604. By the signal transfer voltage Vtran lifting the voltage levels of the first ends of the first storage capacitors 602 and at the same time lifting the voltage levels Vlc of the high-voltage-level electrodes of the corresponding pixel capacitors (Clc) such that the range of the pixel data voltages applied to the pixel capacitors is consistent with the range of the pixel data voltage written in the first storage capacitors 602. Once all the liquid crystals are transferred to the stable states, the backlight is turned on, and at the same time the whole-panel pixel data of the next frame are sequentially written in the corresponding first storage capacitors 602.

The third embodiment of the present invention can overcome the defect of the shrinkage of the range of the pixel data voltages of the pixel capacitor electrode due to charge sharing. The first storage capacitor 602 of the third embodiment does not need to be large, and hence the aperture ratio of the liquid crystal panel can be increased.

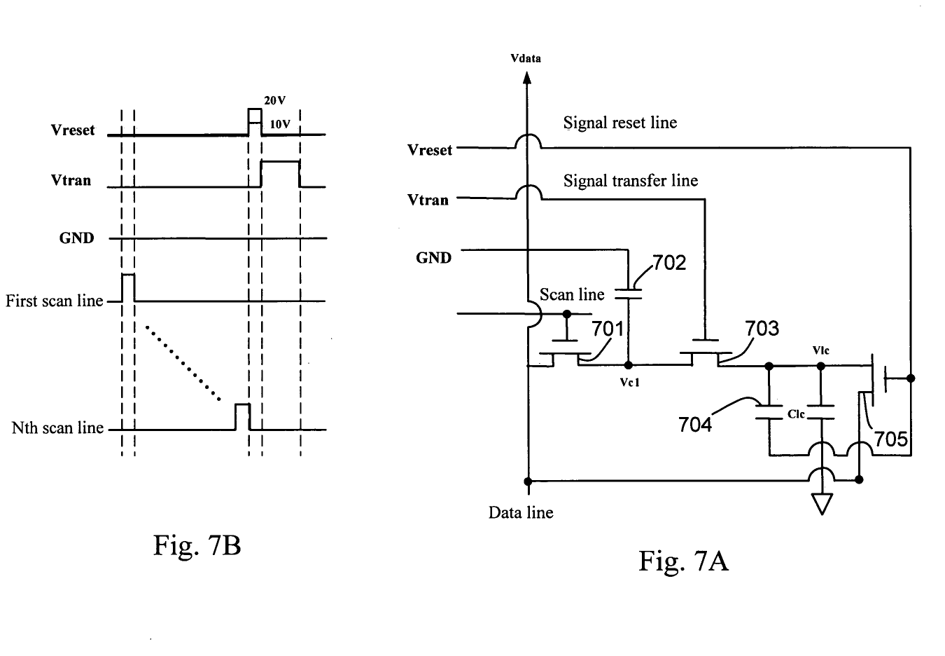

FIG. 7A is a schematic view of a pixel driving circuit for a corresponding pixel according to a fourth embodiment of the present invention. FIG. 7B is a timing diagram of various control signals of the pixel driving circuit of FIG. 7A for a frame. In the fourth embodiment, the pixel driving circuit of the present invention includes a first transistor 701, a first storage capacitor 702, a second transistor 703, a second storage capacitor 704 and a third transistor 705. The first transistor 701 is an N-channel transistor having a gate, a source and a drain, in which the gate is electrically coupled to a pixel scan line, and the source is electrically coupled to a pixel data line. The first storage capacitor 702 has a first end and a second end. The first end of the first storage capacitor 702 is grounded (GND), and the second end thereof is electrically coupled to the drain of the first transistor 701. The first transistor 701 is served as a pixel data writing-in switch. The pixel scan line switches on the first transistor 701 to previously store the pixel data of the next frame to the first storage capacitor 702. The second transistor 703 is an N-channel transistor having a gate, a source and a drain, in which the gate is electrically coupled to a signal transfer line, and the source is electrically coupled to the second end of the first storage capacitor 702. The second storage capacitor 704 has a first end and a second end. The first end of the second storage capacitor 704 is electrically coupled to the drain of the second transistor 703 and a high-voltage-level electrode of a corresponding pixel, and the second end thereof is electrically coupled to a signal reset line. The second transistor 703 is served as a signal transfer switch. The signal transfer line switches on the second transistor 703 to transfer the pixel data pre-stored in the first storage capacitor 702 to the second storage capacitor 704. The third transistor 705 is an N-channel transistor having a gate, a source and a drain, in which the gate is electrically coupled to the signal reset line, the source is electrically coupled to the high-voltage-level electrode of the pixel, and the drain is electrically coupled to the pixel data line. The third transistor 705 is a reset transistor. The signal reset line switches on the third transistor 705 so as to delete the residue pixel data of the corresponding pixel capacitor (Clc) before the pixel data is transferred to the second storage capacitor 704, and when the third transistor 705 is switched on, the pixel data line is grounded, the residue pixel data of the pixel capacitor is removed through the pixel data line. Moreover, the signal reset line is also electrically coupled to the second end of the second storage capacitor 704. In the fourth embodiment, the present invention also employs the signal reset line to output the different reset signal voltages Vreset to adjust the voltage level of the second end of the second storage capacitor 704 after reset. And hence, when the pixel data voltage is transferred to the first end of the second storage capacitor 704, the voltage level of the first end of the second storage capacitor 704 is boosted to (Vdata+Vreset)/2 such that the data voltage of the high-voltage-level electrode of the corresponding pixel capacitor (Clc) is (Vdata+Vreset)/2. The data voltage range of the high-voltage-level electrode of the pixel capacitor (Clc) is extended.

The difference between the fourth embodiment and the third embodiment is the first end of the first storage capacitor 702 is grounded, and the drain of the third transistor (reset transistor) 705 is electrically coupled to the corresponding data line and the reset signal line is electrically coupled to the gate of the third transistor 705 and the second end of the second storage capacitor 704. In the fourth embodiment, when all the third transistors 705 of the whole panel are synchronously switched on, all the corresponding pixel data lines are grounded such that the residue pixel data of all the pixels are synchronously removed through the pixel data lines, and by the different signal reset voltages Vreset to change the voltage level of the high-voltage-level electrode of the corresponding pixel capacitor after reset, and hence the data voltage range of the pixel capacitor is extended. Please refer to FIG. 7B and FIG. 6B, the timing diagram of the control signals of the pixel driving circuit of the fourth embodiment is substantially consistent with that of the third embodiment. The difference between the two embodiments is the dynamic signal Vtran is changed to the dynamic signal Vreset in the fourth embodiment.

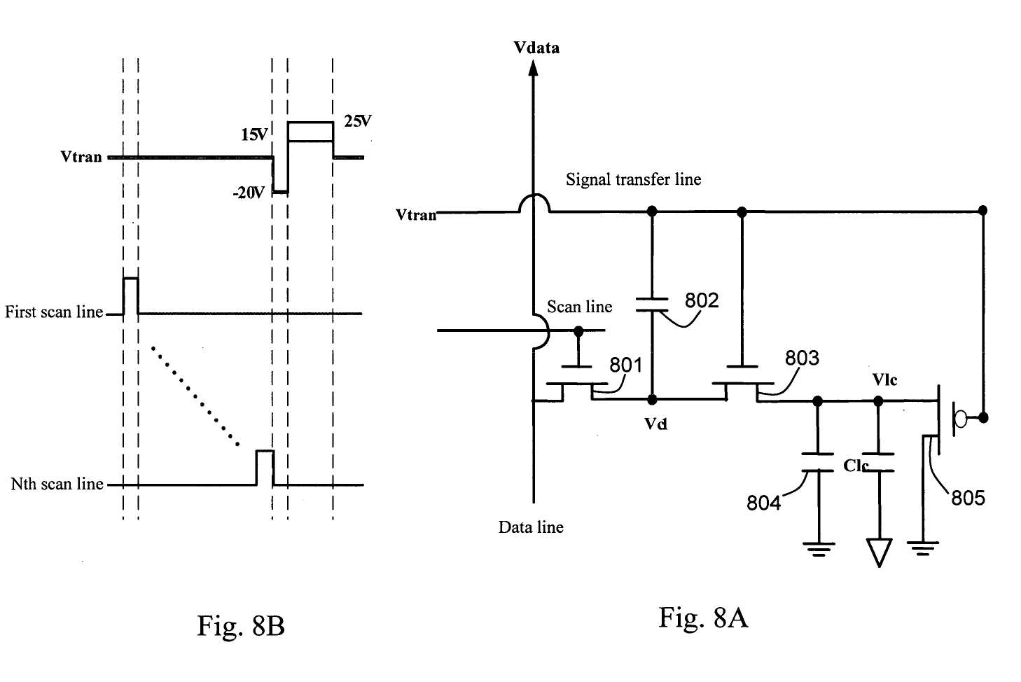

FIG. 8A is a schematic view of a pixel driving circuit for a corresponding pixel according to a fifth embodiment of the present invention. FIG. 8B is a timing diagram of various control signals of the pixel driving circuit of FIG. 8A for a frame. In the fifth embodiment, the pixel driving circuit for a corresponding pixel of the present invention includes a first transistor 801, a first storage capacitor 802, a second transistor 803, a second storage capacitor 804 and a third transistor 805. The first transistor 801 is an N-channel transistor having a gate, a source and a drain, in which the gate is electrically coupled to a pixel scan line, and the source is electrically coupled to a pixel data line. The first storage capacitor 802 has a first end and a second end. The first end of the first storage capacitor 802 is electrically coupled to a signal transfer line, and the second end thereof is electrically coupled to the drain of the first transistor 801. The first transistor 801 is served as a pixel data writing-in switch. The pixel scan line switches on the first transistor 801 to previously store the pixel data of the next frame to the first storage capacitor 802. The second transistor 803 is an N-channel transistor having a gate, a source and a drain, in which the gate is electrically coupled to the signal transfer line, and the source is electrically coupled to the second end of the first storage capacitor 802. The second storage capacitor 804 has a first end and a second end. The first end of the second storage capacitor 804 is electrically coupled to the drain of the second transistor 803 and a high-voltage-level electrode of a corresponding pixel (Clc), and the second end thereof is connected to a voltage source such as a ground voltage. The second transistor 803 is used as a signal transfer switch. The signal transfer line switches on the second transistor 803 to transfer the pixel data pre-stored in the first storage capacitor 802 to the second storage capacitor 804, and by the signal transfer line also electrically coupled to the first end of the first storage capacitor to adjust the voltage level of the high-voltage-level electrode of the corresponding pixel. By the signal transfer line outputting the different signal transfer voltages Vtran to adjust the voltage level of the high-voltage-level electrode of the corresponding pixel. The pixel data voltage range of the high-voltage-level electrode of the pixel is extended. The third transistor 805 is a P-channel transistor having a gate, a source and a drain, in which the gate is electrically coupled to the signal transfer line, the source is electrically coupled to the high-voltage-level electrode of the pixel, and the drain is connected to a voltage source such as a ground voltage. The third transistor 805 is served as a reset transistor. By the signal transfer line also serving as a signal reset line to switch on the third transistor 805, the residue pixel data of the pixel capacitor (Clc) is deleted before the pixel data is transferred to the second storage capacitor 804.

The difference between the fifth embodiment and the third embodiment is the third transistor 805 served as the reset transistor is a P-channel transistor. As such, the signal transfer line also can be used as a signal reset line to electrically couple to the gate of the third transistor 805. Please refer to FIG. 8B and FIG. 6B, in the fifth embodiment, after all the pixel scan lines of the whole panel are scanned, i.e. after all the pixel data of the whole panel are written in the respective first storage capacitors 802, all the signal transfer lines of the whole panel pixels are used as reset signal lines to transmit a negative voltage signal to the respective third transistors 805 so as to delete the residue pixel data of all the pixel capacitors before all the pixel data voltages are transferred to the second storage capacitors 804. After that, all the signal transfer lines of the whole panel deliver a positive voltage signal to switch on the second transistors 803 of the whole panel pixels to synchronously transfer the pixel data of the whole panel pre-stored in the first storage capacitors 802 to the respective second storage capacitors 804 such that all the pixel data voltages are applied to the high-voltage-level electrodes of the respective pixel capacitors Clc. Once all the liquid crystals of the whole panel are transferred to the stable states, the backlight is tuned on, and at the same time the pixel data voltages of the whole panel of the next frame are sequentially written in the respective first storage capacitors 802. Because the first ends of the first storage capacitors 802 are electrically coupled to the respective signal transfer lines, as the third embodiment, the signal transfer lines can output different positive voltage signals Vtran to extend the range of the pixel data voltage of the corresponding pixel electrode. The defect of the shrinkage of the range of the pixel data voltage of the pixel capacitor electrode due to charge sharing is overcome.

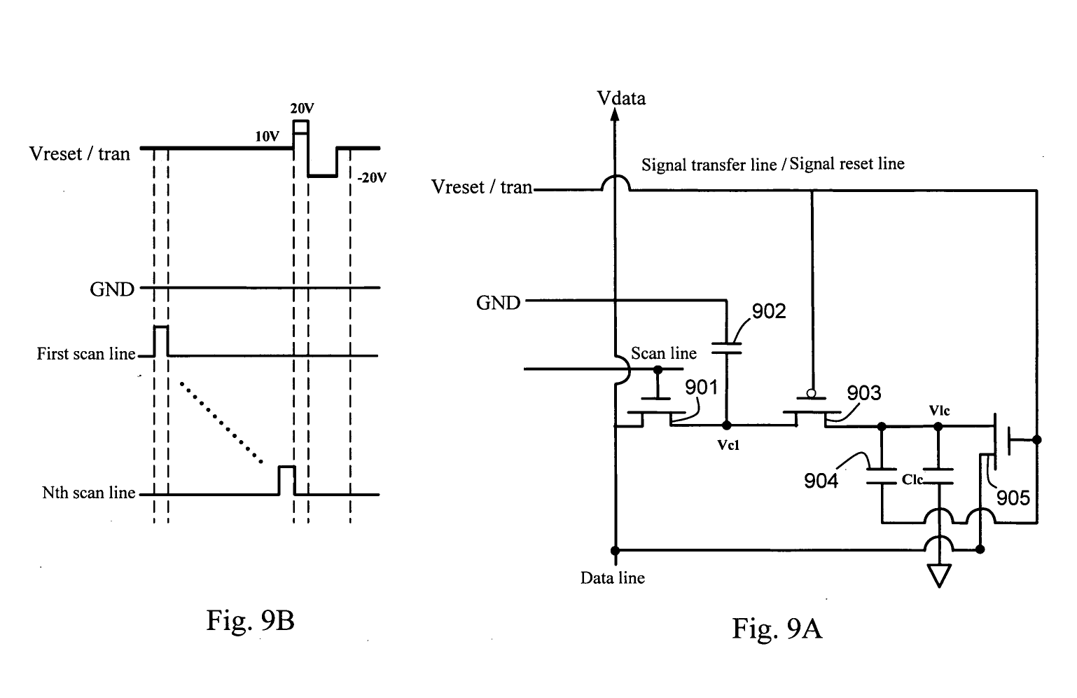

FIG. 9A is a schematic view of a pixel driving circuit for a corresponding pixel according to a sixth embodiment of the present invention. FIG. 9B is a timing diagram of various control signals of the pixel driving circuit of FIG. 9A for a frame. In the sixth embodiment, the pixel driving circuit of the present invention includes a first transistor 901, a first storage capacitor 902, a second transistor 903, a second storage capacitor 904 and a third transistor 905. The first transistor 901 is an N-channel transistor having a gate, a source and a drain, in which the gate is electrically coupled to a pixel scan line, and the source is electrically coupled to a pixel data line. The first storage capacitor 902 has a first end and a second end. The first end of the first capacitor 902 is grounded and the second end thereof is electrically coupled to the drain of the first transistor 901. The first transistor 901 is served as a pixel data writing-in switch. The pixel scan line switches on the first transistor 901 to previously store the pixel data of the next frame to the first storage capacitor 902. The second transistor 903 is a P-channel transistor having a gate, a source and a drain, in which the gate is electrically coupled to a signal transfer line, and the source is electrically coupled to the second end of the first storage capacitor 902. The second storage capacitor 904 has a first end and a second end. The first end of the second storage capacitor 904 is electrically coupled to the drain of the second transistor 903 and a high-voltage-level electrode of a corresponding pixel. The second end of the second storage capacitor 904 is electrically coupled to the signal transfer line. The second transistor 903 is served as a signal transfer switch. The signal transfer line switches on the second transistor 903 to transfer the pixel data pre-stored in the first storage capacitor 902 to the second storage capacitor 904. The third transistor 905 is an N-channel transistor having a gate, a source and a drain, in which the gate is electrically coupled to the signal transfer line, the source is electrically coupled to the high-voltage-level electrode of the pixel, and the drain is electrically coupled to the pixel data line. The third transistor 905 is served as a reset transistor. The signal transfer line is also served as a reset signal line to switch on the third transistor 905 so as to delete the residue pixel data of the corresponding pixel before the pixel data is transferred to the second storage capacitor 904. Once the third transistor 905 is switched on, the pixel data line is grounded, and the residue pixel data of the pixel capacitor is removed through the pixel data line. Moreover, the signal transfer line is also electrically coupled to the second end of the second storage capacitor 904. The signal transfer line can output different voltage signals Vtran/reset to change the voltage level of the high-voltage-level electrode of the corresponding pixel capacitor (Clc) after reset to extend the range of the pixel data voltage of the high-voltage-level electrode of the pixel capacitor when the pixel data voltage is transferred.

The difference between the sixth embodiment and the fourth embodiment is the signal transfer line is also served as a signal reset line in the sixth embodiment, and a P-channel transistor is served as the second transistor (signal transfer switch) 903 and an N-channel transistor is served as the third transistor (reset transistor) 905. Please refer to FIG. 9B, after all the pixel scan lines of the whole panel are scanned, i.e. after all the pixel data of the whole panel are written in the respective first storage capacitors 902, the signal transfer lines of the whole panel deliver a positive voltage signal to the respective third transistors 905 to synchronously switch on the third transistors 905 to delete the residue pixel data of all the pixel capacitors of the whole panel. Then, the signal transfer lines deliver a negative voltage signal to the respective second transistors 903 to synchronously switch on the second transistors 903 to transfer the pixel data voltages pre-stored in the first storage capacitors 902 to the corresponding second storage capacitors 904 such that the pixel data voltages of the whole panel are respectively applied to the corresponding pixel capacitors. Thereafter, the second transistors 903 are switched off. Once all the liquid crystals of the whole panel are transferred to the stable states, the backlight is tuned on, and at the same time the pixel data of the whole panel of the next frame are sequentially written in the corresponding first storage capacitors 902.

While the invention has been described by way of examples and in terms of preferred embodiments, it is to be understood that those who are familiar with the subject art can carry out various modifications and similar arrangements and procedures described in the present invention and also achieve the effectiveness of the present invention. Hence, it is to be understood that the description of the present invention should be accorded with the broadest interpretation to those who are familiar with the subject art, and the invention is not limited thereto.

What is claimed is:

1. A pixel driving circuit comprising a first transistor, a first storage capacitor, an active loading circuit, a second transistor and a second storage capacitor, wherein a pixel data of a next frame is previously stored in said first storage capacitor by switching on said first transistor, and adjusting an output voltage of the pixel data pre-stored in said first storage capacitor by said active loading circuit, and then transferring the output voltage to said second storage capacitor.

2. The pixel driving circuit as claimed in claim 1, wherein said first transistor has a gate, a source and a drain, said gate is electrically coupled to a pixel scan line and said source is connected to a pixel data line, said first storage capacitor has a first end and a second end, said first end is coupled to said drain of said first transistor and said second end is grounded, the pixel data of the next frame is pre-stored in said first storage capacitor by switching on said first transistor through the pixel scan line, said active loading circuit includes a third transistor and a fourth transistor, each of said third transistor and said fourth transistor has a gate, a source and a drain, said source of said third transistor is connected to said drain of said fourth transistor, said gate and drain of said third transistor are electrically coupled to a voltage signal line, the gate of the fourth transistor is electrically coupled to said first end of said first storage capacitor and said source thereof is grounded, said second transistor has a gate, a source and a drain, said gate of said second transistor is electrically coupled to a signal transfer line and said source thereof is connected to said source of said third transistor and said drain of said fourth transistor, and said second storage capacitor has a first end and a second end, said first end of said second storage capacitor is electrically coupled to said drain of said second transistor and a high-voltage-level electrode of a pixel and said second end thereof is connected to a voltage source, the pixel data pre-stored in said first storage capacitor is transferred to said second storage capacitor by switching on said second transistor through said signal transfer line.

3. The pixel driving circuit as claimed in claim 1, wherein said second transistor is an N-channel transistor or a P-channel transistor.

4. The pixel driving circuit as claimed in claim 2, wherein said second transistor is an N-channel transistor or a P-channel transistor.

5. The pixel driving circuit as claimed in claim 4, wherein when said second transistor is a P-channel transistor, said pixel scan line is also served as said signal transfer line.

6. A pixel driving circuit comprising a first transistor, a first storage capacitor, a second transistor, a second storage capacitor and a third transistor, wherein a pixel data of a next frame is previously stored in said first storage capacitor by switching on said first transistor, and by switching on said second transistor through a signal transfer line and said signal transfer line is also electrically coupled to a high-voltage-level electrode of said first storage capacitor to transfer the pixel data pre-stored in said first storage capacitor to said second storage capacitor and at the same time adjusting a voltage level of the high-voltage-level electrode of said second storage capacitor, and by switching on said third transistor to delete residue pixel data before the pixel data is transferred to said second storage capacitor.

7. The pixel driving circuit as claimed in claim 6, wherein said first transistor has a gate, a source and a drain, said gate of said first transistor is electrically coupled to a pixel scan line and said source thereof is electrically coupled to a pixel data line, a low-voltage-level electrode of said first storage capacitor is electrically coupled to said drain of said first transistor, a pixel data of a next frame is previously stored in said first storage capacitor by switching on said first transistor through said pixel scan line, said second transistor has a gate, a source and a drain, said gate of said second transistor is electrically coupled to said signal transfer line and said source thereof is electrically coupled to said low-voltage-level electrode of said first storage capacitor, said second storage capacitor has a high-voltage-level electrode and a low-voltage-level electrode, said high-voltage-level electrode of said second capacitor is electrically coupled to said drain of said second transistor and a high-voltage-level electrode of a pixel, and said low-voltage-level electrode of said second storage capacitor is connected to voltage source, by switching on said second transistor through said signal transfer line, the pixel data pre-stored in said first storage capacitor is transferred to said second storage capacitor, and adjusting a voltage level of said high-voltage-level electrode of said pixel by said signal transfer line simultaneously coupled to said high-voltage-level electrode of said first storage capacitor, and said third transistor has a gate, a source and a drain, said gate of said third transistor is electrically coupled to a signal reset line, said source thereof is electrically coupled to said high-voltage-level electrode of said pixel and said drain thereof is connected to another voltage source lower than said source thereof, by switching on said third transistor through said signal reset line to delete residue pixel data before the pixel data is transferred to said second storage capacitor.

8. The pixel driving circuit as claimed in claim 6, wherein said third transistor is an N-channel transistor or a P-channel transistor.

9. The pixel driving circuit as claimed in claim 7, wherein said third transistor is an N-channel transistor or a P-channel transistor.

10. The pixel driving circuit as claimed in claim 9, wherein when said third transistor is a P-channel transistor, said signal transfer line is also served as said signal reset line.

11. A pixel driving circuit comprising a first transistor, a first storage capacitor, a second transistor, a second storage capacitor and a third transistor, wherein a pixel data of a next frame is previously stored in said first storage capacitor by switching on said first transistor, and by switching on said second transistor to transfer the pixel data of said first storage capacitor to said second storage capacitor, and by switching on said third transistor through a signal reset line and said signal reset line simultaneously electrically coupled to a low-voltage-level electrode of said second storage capacitor to delete residue pixel data before the pixel data is transferred to said second storage capacitor, and at the same time adjusting a voltage level of said low-voltage-level electrode of said second storage capacitor after reset through said signal reset line.

12. The pixel driving circuit as claimed in claim 11, wherein said first transistor has a gate, a source and a drain, said gate of said first transistor is electrically coupled to a pixel scan line and said source thereof is electrically coupled to a pixel data line, a high-voltage-level electrode of said first storage capacitor is grounded and said low-voltage-level electrode thereof is electrically coupled to said drain of said first transistor, the pixel data of the next frame is previously stored in said first storage capacitor by switching on said first transistor through said pixel scan line, said second transistor has a gate, a source and a drain, said gate of said second transistor is electrically coupled to a signal transfer line and said source thereof is electrically coupled to said low-voltage-level electrode of said first storage capacitor, a high-voltage-level electrode of said second storage capacitor is electrically coupled to said drain of said second transistor and a high-voltage-level electrode of a pixel, and a low-voltage-level electrode of said second storage capacitor is electrically coupled to said signal reset line, by switching on said second transistor through said signal transfer line to transfer the pixel data pre-stored in said first storage capacitor to said second storage capacitor, said third transistor has a gate, a source and a drain, said gate of said third transistor has a gate, a source and a drain, said gate of said third transistor is electrically coupled to said signal reset line, said source of said third transistor is electrically coupled to said high-voltage-level electrode of the pixel, and said drain thereof is electrically coupled to the pixel data line, by switching on said third transistor through said reset signal line to delete residue pixel data before the pixel data is transferred to said second storage capacitor, and when said third transistor is switched on, the pixel data line is grounded, and at the same time adjusting a voltage level of said low-voltage-level electrode of said second storage capacitor after reset through said signal reset line.

13. The pixel driving circuit as claimed in claim 11, wherein said second transistor is an N-channel transistor or a P-channel transistor.

14. The pixel driving circuit as claimed in claim 12, wherein when said second transistor is a P-channel transistor, said signal transfer line is also served as sad signal reset line.
